(19) United States
(12) Patent Application Publication
(10) Pub. No.: US 2020/0362598 A1
(43) Pub. Date: Nov. 19, 2020

(54) DOUBLE ACTION VEHICLE LATCH

(71) Applicant: Brose Schliesssysteme GmbH & Co. Kommanditgesellschaft, Wuppertal, Wuppertal (DE)

(72) Inventor: Kim TAYLOR, Farmington Hills, MI (US)

(21) Appl. No.: 16/414,184

(22) Filed: May 16, 2019

(51) Int. Cl. E05B 81/20; E05B 79/20; E05B 81/12

(52) U.S. Cl. CPC E05B 81/20; E05Y 2900/546; E05B 81/13; E05B 79/20

(57) ABSTRACT

A closure system for a vehicle provided with a vehicle body and a closure is provided. The closure system may include an actuator, a catch, and a release lever. The actuator may be configured to move in a first direction between a first actuator position and a second actuator position. The catch may be coupled to the actuator and configured to move from a first catch position to a second catch position to move the closure form a first closure position to a second closure position when the actuator moves from the first actuator position to the second actuator position. The release lever may be coupled to the actuator and configured to move the catch from the second catch position to a third catch position when the actuator moves from the second actuator position to a third actuation position.

### TECHNICAL FIELD

The present disclosure relates to latch assembly particularly a latch assembly for a vehicle.

### BACKGROUND

Vehicles may include one or more closures, such as, hatches, doors, tailgates, or liftgates. Certain closures may close and open automatically, e.g. without the assistance of an operator. Vehicles generally include a seal or other type of weather proofing barrier positioned between the closure and the vehicle body to mitigate external elements such as moisture, precipitation, dirt, debris, and noise from entering the interior of the vehicle. The force applied to the closure, by a latch for example, must be sufficient to overcome pressure associated with the closure and the seal. Also, the vehicle may be equipped with a device or mechanism that may automatically release the latch, so the closure may move to an open position.

### SUMMARY

According to one embodiment, a latch for use in a vehicle closure is provided. The latch may include a base member, a cinching lever, a release lever, and an actuation bracket. The cinching lever may be coupled to the base member and configured to change a state of the latch from a secondary latch state and a primary latch state. The release lever may be coupled to the base member and configured to change the state of the latch from the primary latch state to a released state. The actuation bracket may be coupled to the cinching lever and the release lever. The actuation bracket may be configured to move between a first position, a second position, and a third position. When the actuation bracket moves from the first position to the second position, the cinching lever changes the state of the latch from the secondary latch state to the primary latch state and when the actuation bracket moves from the second position to the third position, the release lever changes the latch state from the primary latch state to the release state.

The actuation bracket may translate in a first direction when the actuation bracket moves between the first position, the second position, and the third position.

The latch may include a pin extending from the cinching lever into a slot defined by the actuation bracket. The slot may include a first portion and a second portion. When the actuation bracket moves from the first position to the second position, the pin may move along the first portion of the slot.

When the pin moves along the first portion of the slot, the cinching lever may rotate to move a catch to change the latch state from the secondary latch state to the primary latch state.

The second portion of the slot may translate about the pin when the actuation bracket moves from the second position to the third position.

When the second portion of the slot translates about the pin, the release lever may rotate to change the state of the latch from the primary latch state to the release state.

According to another embodiment, a closure system for a vehicle provided with a vehicle body and a closure is provided. The closure system may include a spindle assembly, a two-stage latch assembly, and a cable. The spindle assembly may be coupled to the vehicle body and the closure. The two-stage latch assembly may be configured to change from a secondary latch state to a primary latch state to move the closure from a first position to a second position and change from the primary latch state to a release state so that the closure may move from the second position to a third position. The cable may include a first end coupled to the two-stage latch assembly and a second end coupled to the spindle assembly. When the spindle assembly moves from a first spindle position to a second spindle position, the two-stage latch changes from the secondary latch state to the primary latch state and when the spindle assembly moves from the second spindle position to a third spindle position, the latch changes from the primary latch state to the release state.

The two-stage latch assembly may include a cinching lever configured to actuate to change the state of the two-stage latch assembly from the secondary latch state to the primary latch state.

The two-stage latch assembly may include a release lever configured to actuate to change the state of the two-stage latch assembly from the primary latch state to the release state

The cinching lever and the release lever may each rotate in a first rotational direction to change the latch from the secondary latch state to the primary latch state and to change latch from the primary latch state to the release state, respectively.

The two-stage latch assembly may include an actuation bracket that may be coupled to the cinching lever and the release lever.

The two-stage latch assembly may include a release bar that extends from the release lever and coupled to the actuation bracket.

The two-stage latch assembly may include a housing provided with a first side and second side opposite the first. The cinching lever may be disposed on the first side and the release lever may be disposed on the second side.

According to yet another embodiment, a closure system for a vehicle including a vehicle body and a closure, is provided. The closure system may include an actuator, a catch, and a release lever. The actuator may be configured to move in a first direction between a first actuator position and a second actuator position. The catch may be coupled to the actuator and configured to move from a first catch position to a second catch position to move the closure form a first closure position to a second closure position when the actuator moves from the first actuator position to the second actuator position. The release lever may be coupled to the actuator and configured to move, directly or indirectly, the catch from the second catch position to a third catch position when the actuator moves from the second actuator position to a third actuation position.

In one or more embodiments, the first direction may be linear.

The first closure position may be a partially closed position and the second closure position may be a fully closed position.

The actuator may include a spindle drive configured to move linearly in the first direction.

The actuator may also include an actuator bracket configured to move linearly in a second direction.

The actuator may also include a cable provided with a first end, coupled to the spindle drive, and a second end coupled to the actuator bracket.

### BRIEF DESCRIPTION OF THE DRAWINGS

FIG. 1 is a partial-plan view of an exemplary vehicle that includes an exemplary closure in an open position.

FIG. 2 is a perspective view of an exemplary latch.

FIG. 3 is a partial-plan view of an exemplary vehicle that includes an exemplary closure in a partially closed position.

FIG. 4 is a plan view of an exemplary latch in a secondary state or secondary position.

FIG. 5 is a partial-plan view of an exemplary vehicle that includes an exemplary closure in a fully closed position.

FIG. 6 is a plan view of an exemplary latch in a primary state or primary position.

FIG. 7 is a plan view of an exemplary latch in a release state or release position.

FIG. 8 is a perspective view of an exemplary latch.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

The term “secondary state” or “secondary position” may be used herein to describe disclosed or claimed embodiments. The term “secondary state” or “secondary position” means the latch is engaged with the striker, but a secondary lock is not engaged. The term “secondary state” or “secondary position” may also refer to the closure being in a partially closed position.

The term “primary state” or “primary position” may be used herein to describe disclosed or claimed embodiments. The term “primary state” or “primary position” means the latch has moved from the secondary state to pull the closure to overcome the seal into a fully closed position.

Vehicle latches or locks capable of performing an automatic opening or release function and a closing or cinching function are known. As one example, U.S. Publication No. 2004/0135378 discloses a latch with a pre-catch, a main catch, and a ratchet that may each be moved into an open-position, a pre-catch position, and a main catch position, and is hereby incorporated by reference in its entirety. As another example, U.S. Publication No. 2016/0108653 discloses a detent mechanism that includes a pivotable holding part and a pivotable blocking part and is hereby incorporated by reference in its entirety.

Vehicle latches may be required to perform certain functions. For example, when the vehicle closure is in a partially closed position, the latch may be in a secondary state and the latch may change from the secondary state to a primary state to move the closure from the partially closed position to a fully closed position, thus overcoming the pressure of a seal disposed between the closure and the vehicle body. The latch may also be required to move from the primary position to an opened or release state. Changing the status of the latch from the secondary state to the primary state and from the primary state to the release state or open state may require one or more dedicated electric motors to alter one or more positions of the latch. Latches that require one or more electric motors to change the status of the latch may be relatively more expensive and heavier compared to latches that do not include one or more electric motors that are configured to change the state of the latch.

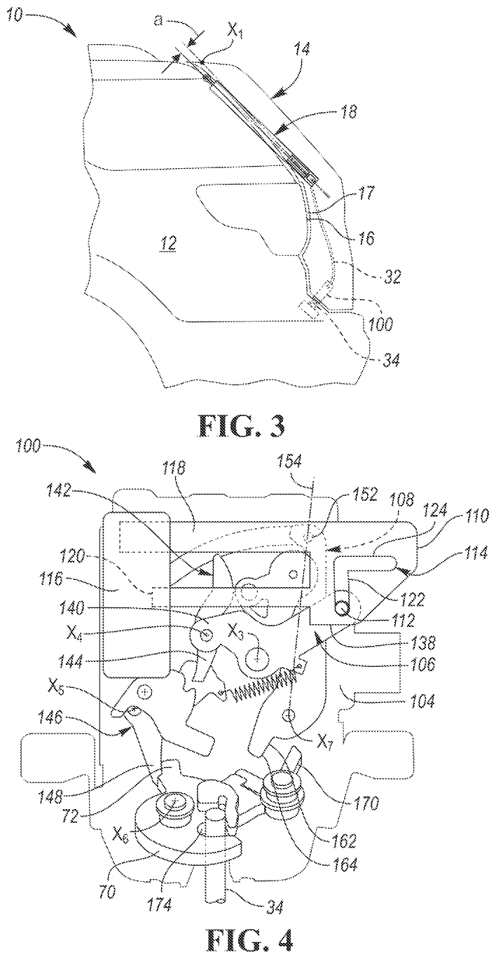

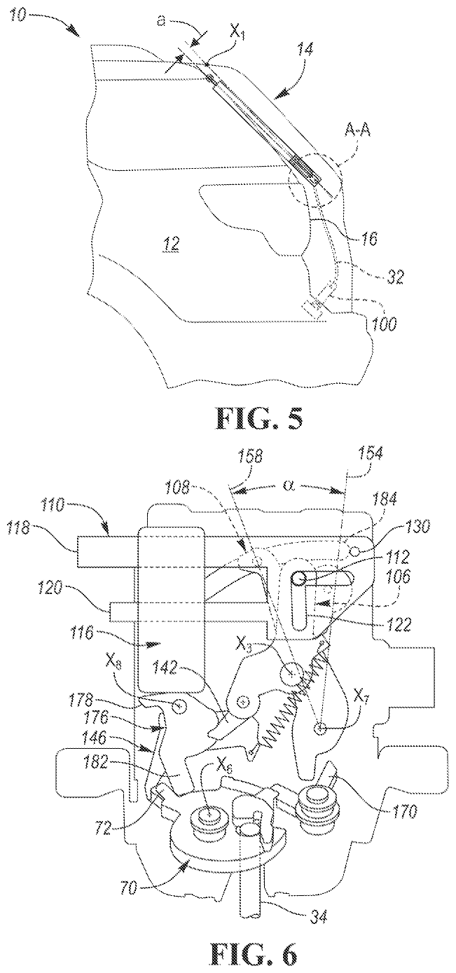

Referring to FIG. 1 through FIG. 7, a closure system for a vehicle 10 provided with a tailgate, liftgate, or closure 14 that may be pivotally attached to the vehicle body 12. The closure 14 may move from an open position (FIG. 1) to a partially closed position (FIG. 3), to a closed position (FIG. 5). In the partially closed position and the closed position, the closure 14 covers or closes one or more openings 16 defined by the vehicle body 12. In one or more embodiments, “partially closed” refers to the closure 14 being adjacent to the vehicle body 12 but not sealed. In one or more embodiments, the term “fully closed” means the closure 14 is in a sealed position.

A drive mechanism, such as a spindle assembly, linear drive mechanism, linear drive assembly 18, or other suitable mechanism may be coupled, directly or indirectly, to the vehicle body 12 and the closure 14. The linear drive 18 may extend or retract, by actuating one or more motors (now shown), to move the closure 14 between the open position, the partially closed position, and the fully closed position. In one or more embodiments, the closure 14 may move from the open position to the partially closed position by gravity or by a user-applied force, or some combination thereof.

A latch assembly such as a two-stage latch assembly 100 may be coupled to the closure 14 or a portion of the vehicle body 12. The two-stage latch assembly 100 may be configured to move from an open state or released state to a secondary latch state. The latch assembly 100 may be further configured to move from the secondary latch state to a primary latch state. When the latch assembly 100 is in the secondary latch state, the closure 14 may be in the partially closed position.

The latch assembly 100 may include a catch 70 that may be pivotally coupled to a base member 104. The catch 70 may engage a striker 34 that may be disposed on or within the vehicle body 12 or on the vehicle closure 14.

The latch assembly 100 may also include a cinching lever 106 that may be coupled, directly or indirectly, to the base member 104. The cinching lever 106 may be configured to move the catch 70 between the secondary latch state, the primary latch state, and the release state. For example, the cinching lever 106 may be actuated, e.g., translated, rotated, pivoted, to actuate the catch and pull the closure 14 from the partially closed position to the closed position. The cinching lever 106 may be configured to apply force to the catch 70 to overcome a pressure associated with the seal disposed between the closure 14 and the vehicle body 12.

The latch assembly 100 may include a release lever 108 that may be coupled, directly or indirectly, to the base member 104. The release lever 108 may be configured to move, e.g., translate, rotate, pivoted, to move the pawl so that the pawl disengages the striker 34.

The cinching lever 106 and the release lever 108 may be coupled to one another by an actuation member 110. As one example, a cinching lever pin 112 may extend from the cinching lever 106 into a slot 114 that is defined by the actuation member 110. A release pin or rod 130 may extend from the release lever 108 so that it is coupled to the actuation member 110. The actuation member 110 may be configured to translate in a first direction, indicated by directional arrow D, so that as the actuation member 110 translates in the first direction, the cinching lever 106 and the release lever 108 are each actuated e.g., rotated.

In one or more embodiments, the actuation bracket 110 may be slidably coupled to the base member 104 by a guide 116. The actuation bracket 110 may include one or more elongated portions, such as a first elongated arm 118 and a second elongated arm 120. The first elongated arm 118 and the second elongated arm 120 may be coupled to the guide 116 and configured to translate with respect to the base member 104 and the guide 116. One or more portions of actuation bracket 110 may be coupled to the linear drive 18 by the cable 32.

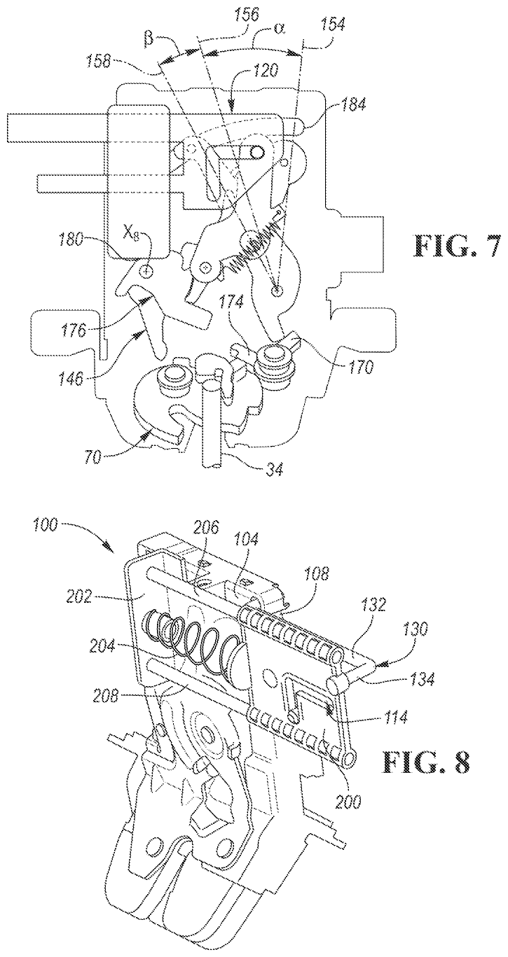

The actuation member 110 may be configured to move between a first position (FIG. 4), a second position (FIG. 6), and a third position (FIG. 7). As the actuation member 110 moves between the first, second, and third positions, the actuation member 110 may move in the first direction. When the actuation member 110 moves from the first position to the second position, the cinching lever moves the pawl, e.g., directly or indirectly, from the secondary latch state to the primary latch state. When the actuation bracket 110 moves from the second position to the third position, the release lever 108 may move the pawl, e.g, directly or indirectly, from the primary latch state to a release state. When the latch 100 is in the release state, the closure 14 may be decoupled or unlocked from the striker 34 and the vehicle body 12 so that the closure 14 may move to the open position (FIG. 1).

The slot 114 defined by the actuation member 110 may include a first portion 122 and a second portion 124. In one or more embodiments, the first portion 122 and the second portion 124 of the slot 114 may be arranged orthogonally to one another. As the actuation member 110 moves between the first position and the second position, the cinching lever pin 112 may move along the first portion of the 122 of the slot 114. As the actuation member 110 moves from the second position to the third position, the second portion 124 of the slot 114 may move, e.g., translate about the cinching lever pin 112 so that the cinching lever is not actuated or moved. As the actuation member 110 moves from the second position to the third position, the release rod 130 may translate in the first direction to move, e.g., rotate the release lever 108 to move the catch 70 from the primary latch state to a release state. As the actuation bracket 110 moves between the first position and the second position, the release lever 108 may move or rotate by a predetermined rotational angle α. The predetermined rotational angle α may correspond to an idle travel, or travel that is insufficient to change the state of the pawl from the primary state to the release state.

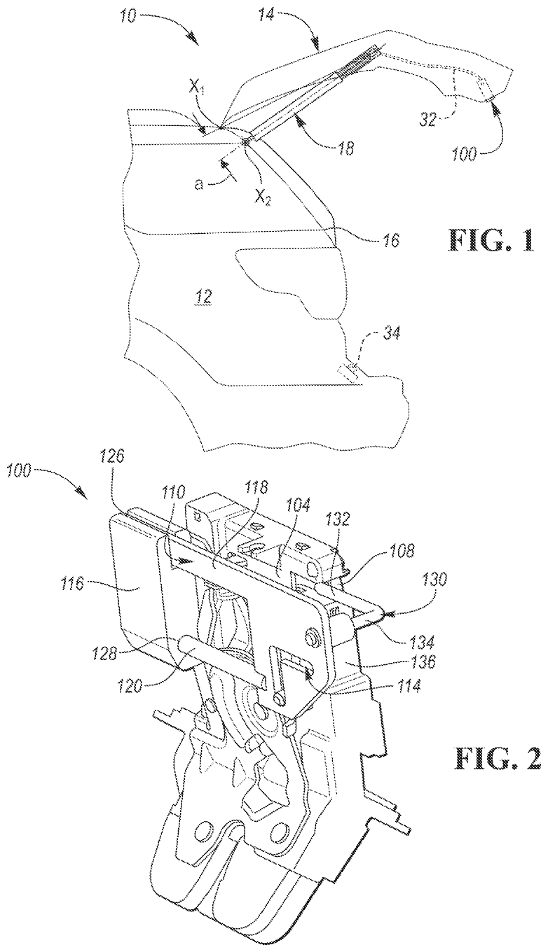

Referring to FIG. 2, a perspective view of the latch assembly 100 according to one or more embodiments is provided. As previously described, the latch assembly 100 includes a base member 104 and a cinching lever 106 and a release lever 108 each coupled to the base member 104. The latch assembly 100 may include a guide 116 such as a guide bracket that defines a first aperture or guide slot 126 and a second aperture 128. The guide slot 126 may be configured to receive a first arm 118 of the actuation bracket 110 and the second aperture 128 may be configured to receive a second arm 120 of the actuation bracket 110.

In one or more embodiments, the release rod 130 may include a first portion 132 directly connected to the release lever and a second portion 134 that may be fixed to the actuation bracket 110. The second portion 134 may be fixed to the actuation bracket 110 directly or indirectly. As one example, a sleeve may be fixed to the actuation bracket 110 and the sleeve may receive the second portion 134 of the release rod 130.

FIG. 2 illustrates the latch with an inner cover 136 that may be disposed between the actuation bracket 110 and the base member 104. For the purposes of clarity, the rear cover of the latch 100, configured to engage the base member 104 and be disposed on a side of the release lever 108 that is opposite of the side of the release lever 108 that is adjacent to the base member 104.

Referring to FIG. 3, a partial plan view of the vehicle 10 provided with the closure 14 in a partially open position is illustrated. The closure 14 may move from the open position to the partially closed position by actuating the linear drive 18 by an electric motor (not shown), or by disengaging a locking member and allowing the weight of the closure move to the partially closed position, or some combination thereof. In this position, the closure 14 has not overcome the pressure of a seal 17 between the opening 16 and the closure 14. While a visible gap is shown between the closure 14 and the vehicle body 12, this gap is exaggerated for clarity.

Referring to FIG. 4, a plan view of the latch assembly 100 in the secondary state or position is illustrated. For the purpose of clarity, the inner cover 136 is not illustrated. In this position or state, the actuation member 110 may be in the first position and the cinching lever pin 112 may be disposed in the first portion 122 of the slot 114. The cinching lever 106 may be pivotally coupled to the base member 104 by a fastener at a pivot point X₃. The cinching lever 106 may include a first arm 138 and a second arm 140. The cinching lever pin 112 may extend from the first arm 138 and the second arm 140 may engage a first lever arm 142. The first lever arm 142 and the second arm 140 of the cinching lever may each be pivotally coupled to the base member 104 by a fastener at a pivot point X₄. The first lever arm 142 may include a first end 144 that may be configured to engage a second lever arm 146. The second lever arm 146 may include a first end 148 that is configured to engage a protrusion 72 defined by a catch 70. The second lever arm 146 may be pivotally coupled to the base member 104 by a fastener at a pivot point X₅.

The release lever 108 may be pivotally coupled the base member by a fastener (not shown) at a pivot point X₇ and include a first end 152 and a second end 162. The first end 152 of the release lever 108 may define an aperture that is configured to receive or engage the release arm 130. When the latch assembly 100 is in the secondary state or the open state, the release lever 108 may extend along a plane 154. As will be described in greater detail below, the second end 162 of the release lever 108 may define a release surface 164 that may be configured to engage a release cam 170 so that the release cam 170 disengages from the catch 70.

The catch 70 may define a notch or opening 174 that may be configured to engage the striker 34. The catch 70 may be pivotally coupled the base member about a pivot point X₆. In one or more embodiments, the catch 70 may be rotated e.g., in the counter-clockwise direction from the position shown, associated with the secondary latch state, to the position shown in FIG. 6, associated with the primary state.

In one or more embodiments, the latch assembly 100 includes a first cam 176 that may be pivotally coupled to the base member 104 by a fastener at a pivot point X₈. The first cam 176 may include a first arm 178 and a second arm 182. A detent or recess 180 may be formed between the first arm 178 and the second arm 182.

Referring specifically to FIG. 5, the closure 14 is shown in the fully closed position. In this position, the closure 14 may have overcome the pressure associated with the seal 17 so that it is fully closed.

Referring specifically to FIG. 6, the latch assembly 100 in the primary state or primary position is illustrated. Here, the catch 70 has rotated in the counter-clockwise direction, from the position shown in FIG. 4. Note, the catch 70 may rotate in a clockwise direction in other embodiments. While the catch 70 rotates from the position shown in FIG. 4 to the position shown in FIG. 6, the catch 70 may act upon e.g., pull against the striker 34 to move the closure 14 from the partially closed position (FIG. 3) to the fully closed position (FIG. 5).

In one or more embodiments, the catch 70 may rotate about the rotational point X₆ in response to rotation of the first cam 176. For example, as the first cam 176 is rotated e.g., in the clockwise direction, the second arm 182 of the first cam 176 engages the catch 70, such as the protrusion 72, of the catch 70. The first cam 176 may be rotated in response to rotation e.g., of the second lever arm 146. For example, as the second lever arm 146 rotates, a portion of the second lever arm 146 engages the first arm 178 of the first cam 176 to rotate the first cam 176 in the clockwise direction. When the catch 70 is in the primary position, the second arm 182 of the first cam 176 may stop the catch from rotating in the clockwise direction.

The second lever arm 146 may be rotated in the clockwise direction in response to rotation of the first lever arm 142. For example, the first lever arm 142 may rotate to disengage from the second lever arm 146 so the second lever arm 146 may rotate in the clockwise direction. The second lever arm 146 may rotate in response to rotation e.g., in the counter-clockwise direction, of the cinching lever 106. As the actuation bracket 110 moves or translates in the first direction between the first position to the second position, the release lever 108 may rotate about a rotational point X₇ from the first plane 154 to the second plane 156, by the rotational angle α. As previously mentioned, the rotation of the release lever 108 by the rotational angle α may be referred to as idle travel.

As previously mentioned, the cinching lever 106 may rotate in response to the actuation bracket 110 translating between the position of the actuation bracket 110 shown in FIG. 4 and the position of the actuation bracket 110 shown in FIG. 6. As one example, the cinching lever pin 112 moves along the first portion 122 of the slot 114 defined by the actuation member 110 and the cinching lever 106 rotates as the actuation member 110 moves in the first direction between the first position (FIG. 4) and the second position (FIG. 6).

Referring to FIG. 7, a plan view of the latch assembly 100 in the release state or release position is illustrated. To change the state of the latch from the primary state or the secondary state to the release state, the release lever 108 may rotate by a second rotational angle β from the second plane 156 to a third plane 158. Actuating the linear drive 18 e.g. retracting, pulls the cable 32 and the actuation bracket 110 to the position illustrated. As the actuation bracket 110 moves, the second portion 124 of the slot 114 may move about the cinching pin 112.

In one or more embodiments, the release lever may move along a release depression or release slot 184 defined by the base member 104. As the release lever 108 rotates from the second plane 156 to the third plane 158, a release surface 164 of the second end 162 of the release lever 108 may engage the release cam 170. As one example, the release surface 164 engages a first arm 172 to rotate the release cam 170 so that a second arm 148 of the release cam disengages the from the catch 70.

As the release lever 108 rotates, the second lever arm 146 and first cam 176 may rotate in a counter-clockwise direction to move the catch 70 in the clockwise direction.

In one or more embodiments, the release lever 108 and the cinching lever 106 may be eccentric cams that are configured to engage one another such that as the cinching lever 106 rotates, the release lever 108 rotates.

Referring to FIG. 8, a perspective view of a vehicle latch 100 according to one or more embodiments is provided. In one or more embodiments the latch 100 may include a guide bracket 202 and a pair of guide rails 206, 208. An actuation member 200 may be disposed on and move along the guide rails 206, 208. A displacement member, such as a spring 204 may be disposed between the actuation member 200 and the guide bracket 202. The spring 204 may compress as the actuation member 200 moves towards the guide bracket 202. The spring 204 may bias the actuation member 200 away from the guide bracket once a state of the latch 100 is in the release state.

### PARTS LIST

10 vehicle
12 vehicle body
14 vehicle closure
14 closure
16 opening
17 seal
18 linear drive
32 cable
34 striker
70 catch
72 protrusion
100 latch
104 base member
106 cinching lever
108 release lever
110 actuation member
112 cinching lever pin
114 slot
116 guide
118 elongated arm
120 second arm
122 first portion
124 second portion
126 guide slot
128 second aperture
130 rod
130 release rod
132 first portion
134 second portion
136 inner cover
138 first arm
140 second arm
142 first lever arm
144 first end
146 second lever arm
148 second arm
148 first end
154 first plane
156 second plane
158 third plane
162 second end
164 release surface
170 release cam
172 first arm
174 opening
176 first cam
178 first arm
180 recess
182 second arm
184 release slot
200 actuation member
201 latch
201 vehicle latch
202 guide bracket
204 spring
206 guide rails
208 guide rails

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A latch for use in a vehicle closure, the latch comprising:
a base member;
a cinching lever coupled to the base member and configured to change a state of the latch from a secondary latch state and a primary latch state;
a release lever coupled to the base member and configured to change the state of the latch from the primary latch state to a released state; and
an actuation bracket coupled to the cinching lever and the release lever, wherein the actuation bracket is configured to move between a first position, a second position, and a third position, wherein
when the actuation bracket moves from the first position to the second position, the cinching lever changes the state of the latch from the secondary latch state to the primary latch state, and
when the actuation bracket moves from the second position to the third position, the release lever changes the latch state from the primary latch state to the release state.

2. The latch of claim 1, wherein the actuation bracket translates in a first direction when the actuation bracket moves between the first position and the second position.

3. The latch of claim 2, wherein the actuation bracket moves in the first direction when the actuation bracket moves between the second position and the third position.

4. The latch of claim 1, further comprising a pin extending from the cinching lever into a slot defined by the actuation bracket and including a first portion and a second portion, and wherein when the actuation bracket moves from the first position to the second position, the pin moves along the first portion of the slot.

5. The latch of claim 4, wherein when the pin moves along the first portion of the slot, the cinching lever rotates to move a cam to change the latch state from the secondary latch state to the primary latch state.

6. The latch of claim 4, wherein the second portion of the slot translates about the pin when the actuation bracket moves from the second position to the third position.

7. The latch of claim 6, wherein when the second portion of the slot translates about the pin, the release lever rotates to change the state of the latch from the primary latch state to the release state.

8. A closure system for a vehicle provided with a vehicle body and a closure, the closure system comprising:
a spindle assembly coupled to the vehicle body and the closure;
a two-stage latch assembly configured to change from a secondary latch state to a primary latch state to move the closure from a first position to a second position, and change from the primary latch state to a release state so that the closure may move from the second position to a third position; and
a cable including a first end coupled to the two-stage latch assembly and a second end coupled to the spindle assembly, wherein when the spindle assembly moves from a first spindle position to a second spindle position, the two-stage latch changes from the secondary latch state to the primary latch state, and wherein when the spindle assembly moves from the second spindle position to a third spindle position, the latch changes from the primary latch state to the release state.

9. The closure system of claim 8, wherein the two-stage latch assembly includes a cinching lever configured to actuate to change the state of the two-stage latch assembly from the secondary latch state to the primary latch state.

10. The closure system of claim 9, wherein the two-stage latch assembly includes a release lever configured to actuate to change the state of the two-stage latch assembly from the primary latch state to the release state.

11. The closure system of claim 10, wherein the cinching lever rotates in a first rotational direction to change the latch from the secondary latch state to the primary latch state and wherein the release lever rotates in the first rotational direction to change the latch from the primary latch state to the release state.

12. The closure system of claim 11, wherein the two-stage latch assembly includes an actuation bracket, wherein the actuation bracket is coupled to the cinching lever and the release lever.

13. The closure system of claim 12, wherein the two-stage latch assembly includes a release bar extending from the release lever to the actuation bracket.

14. The closure system of claim 13, wherein the two-stage latch assembly includes a housing provided with a first side and second side opposite the first, and wherein the cinching lever is disposed on the first side and the release lever is disposed on the second side.

15. A closure system for use with a vehicle provided with a closure coupled to a vehicle body, the closure system comprising:
an actuator configured to move in a first direction between a first actuator position and a second actuator position;
a catch coupled to the actuator and configured to move from a first catch position to a second catch position to move the closure from a first closure position to a second closure position when the actuator moves from the first actuator position to the second actuator position; and
a release lever coupled to the actuator and configured to move the catch from the second catch position to a third catch position when the actuator moves from the second actuator position to a third actuator position.

16. The closure system of claim 15, wherein the first direction is linear.

17. The closure system of claim 15, wherein the first closure position is a partially closed position and the second closure position is a fully closed position

18. The closure system of claim 15, wherein the actuator includes a spindle drive configured to move linearly in the first direction.

19. The closure system of claim 18, wherein the actuator includes an actuator bracket configured to move linearly in a second direction.

20. The closure system of claim 19, wherein the actuator includes a cable provided with a first end, coupled to the spindle drive, and a second end coupled to the actuator bracket.
